(19) United States
(12) Patent Application Publication
(10) Pub. No.: US 2013/0161064 A1
(43) Pub. Date: Jun. 27, 2013

(54) COMPOSITION FOR WIRE COATING MATERIAL, INSULATED WIRE, AND WIRING HARNESS

(71) Applicants: Tatsuya Shimada, Yokkaichi-shi (JP); Masashi Kimura, Yokkaichi-shi (JP); Kousuke Shiraki, Yokkaichi-shi (JP); Masashi Sato, Yokkaichi-shi (JP)

(72) Inventors: Tatsuya Shimada, Yokkaichi-shi (JP); Masashi Kimura, Yokkaichi-shi (JP); Kousuke Shiraki, Yokkaichi-shi (JP); Masashi Sato, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/820,646

(22) PCT Filed: Sep. 5, 2011
(86) PCT No.: PCT/JP2011/070173

§ 371 Date: Mar. 4, 2013

(30) Foreign Application Priority Data
Sep. 10, 2010 (JP) 2010-202975

(51) Int. Cl. C09D 123/06; H01B 7/00; H01B 3/44; C09D 151/00

(52) U.S. Cl. CPC C09D 123/06; C09D 151/003; H01B 7/0045; H01B 3/44
USPC 174/113 R; 523/435; 524/94; 428/391

(57) ABSTRACT

To provide a composition for a wire coating material, which requires no electron irradiation crosslinking, and requires a filler defining a flame retardant agent as less as possible, and from which an insulated wire having a high heat resistance and a high gel fraction can be produced, and to provide an insulated wire and a wiring harness containing the composition. The composition contains (A) silane-grafted polyolefin, which is polyolefin to which a silane coupling agent is grafted, (B) undenatured polyolefin, (C) functional-group modified polyolefin modified by one or more functional groups selected from a carboxylic acid group, an acid anhydride group, an amino group, and an epoxy group, (D) a bromine flame retardant having a phthalimide structure, or a bromine flame retardant having a phthalimide structure and an antimony trioxide, (E) a crosslinking catalyst, and (F) a zinc sulfide, or a zinc oxide and an imidazole compound.

### TECHNICAL FIELD

The present invention relates to a composition for a wire coating material, an insulated wire, and a wiring harness, and more specifically relates to a composition for a wire coating material favorable for a wire coating material of an insulated wire that is used in a location of which high heat resistance is required such as a wiring harnesses for automobile, an insulated wire containing the composition, and a wiring harness containing the composition.

### BACKGROUND ART

Conventionally, a crosslinked polyvinyl chloride resin wire or a crosslinked polyolefin wire is used as an insulated wire for use in a high-temperature location such as wiring harnesses for automobile. These crosslinked wires are mainly electron irradiation crosslinked.

However, there arises a problem that the cost for facilities rises because an expensive device for electron irradiation crosslinking is required, which leads to increases in the cost of product. Thus, a silane-crosslinkable polyolefin composition, which can be crosslinked with low-cost facilities, has been receiving attention (see PTL 1 to PTL 3).

### CITATION LIST

### Patent Literature

PTL 1: Patent JP 2000-212291
PTL 2: Patent JP 2000-294039
PTL 3: Patent JP 2006-131720

### SUMMARY OF INVENTION

### Technical Problem

However, because a filler that defines a flame retardant agent needs to be added to the silane-crosslinkable polyolefin composition in order to satisfy flame retardancy that is a main essential property of a wire for automobile, there arises a problem that a mechanical property of the wire for automobile is deteriorated when a great amount of an inorganic flame retardant agent typified by metal hydroxide is added as the filler. In addition, there arises a problem that a gel fraction that defines an indicator of crosslinking degree decreases when a halogenous organic flame retardant agent having a high flame-retardant effect is used.

In addition, when the silane-crosslinkable material, which is referred to also as a water-crosslinkable material, is used, crosslinking is promoted by moisture in the air during a heat molding process, so that there arises a problem that an unintended sub-stance is generated. In order to solve this problem, it is necessary to minimize the number of times of the heating process as much as possible. Thus, it is general to prepare a masterbatch that contains the flame retardant agent and a non-silane resin, and then mix the masterbatch and silane-crosslinkable polyolefin. However, the non-silane resin defines a non-crosslinkable resin, so that the crosslinked resin has a low crosslinking degree. When the crosslinked resin has a low cross-linking degree, the heat resistance and gel fraction thereof decrease, which cannot fulfill automobile specifications.

The present invention is made in view of the problems described above, and an object of the present invention is to provide a composition for a wire coating material, which requires no electron irradiation Crosslinking, and requires a filler that defines a flame retardant agent as less as possible, and from which an insulated wire having a high heat resistance and a high gel fraction can be produced, and to provide an insulated wire containing the composition, and a wiring harness containing the composition.

### Solution to Problem

To achieve the objects and in accordance with the purpose of the present invention, a composition for a wire coating material of the present invention contains

(A) silane-grafted polyolefin, which is polyolefin to which a silane coupling agent is grafted;

(B) undenatured polyolefin;

(C) functional-group modified polyolefin, which is modified by a one or a plurality of functional groups selected from the group consisting of a carboxylic acid group, an acid anhydride group, an amino group, and an epoxy group;

(D) either one of
a bromine flame retardant having a phthalimide structure, and
a bromine flame retardant having a phthalimide structure and an antimony trioxide;

(E) a crosslinking catalyst; and

(F) either one of
a zinc sulfide, and
a zinc oxide and an imidazole compound.

In another aspect of the present invention, an insulated wire of the present invention contains a wire coating material that contains the composition for the wire coating material described above, the composition being water-crosslinked.

Yet, in another aspect of the present invention, an insulated wire that contains a wire coating material that contains an (a) component that contains (A) silane-grafted polyolefin, which is polyolefin to which a silane coupling agent is grafted, a (b) component that contains (B) undenatured polyolefin, (C) functional-group modified polyolefin, which is modified by a one or a plurality of functional groups selected from the group consisting of a carboxylic acid group, an acid anhydride group, an amino group, and an epoxy group, (D) either one of a bromine flame retardant having a phthalimide structure, and a bromine flame retardant having a phthalimide structure and an antimony trioxide, and (F) either one of a zinc sulfide, and a zinc oxide and an imidazole compound, and a (c) component that contains polyolefin and (E) a crosslinking catalyst dispersed in the polyolefin, wherein the (a), (b) and (c) components are kneaded to be molded as the wire coating material, and the wire coating material is water-crosslinked.

Yet, in another aspect of the present invention, a wiring harness of the present invention includes the insulated wire described above.

### Advantageous Effects of Invention

Contains the (A) to (F) components described above, the composition for the wire coating material of the present invention, the insulated wire of the present invention, and the wiring harness of the present invention require no electron irradiation crosslinking, require a filler that defines a flame retardant agent as less as possible, and have a high heat resistance and a high gel fraction.

### DESCRIPTION OF EMBODIMENTS

A detailed description of preferred embodiments of the present invention will now be provided. Examples of the polyolefins used in (A) the silane-grafted polyolefin, (B) the undenatured polyolefin, and (C) the functional-group modified polyolefin include the following polyolefins.

Examples of the polyolefins include polyolefin such as polyethylene and polypropylene, a homopolymer of the other olefins, an ethylene copolymer such as an ethylene-alpha-olefin copolymer, an ethylene-vinyl acetate copolymer, an ethylene-acrylic ester copolymer and an ethylene-methacrylic ester copolymer, and a propylene copolymer such as a propylene-alpha-olefin copolymer, a propylene-vinyl acetate copolymer, a propylene-acrylic ester copolymer and a propylene-methacrylic ester copolymer. They may be used singly or in combination. Among them, the polyethylene, the polypropylene, the ethylene-vinyl acetate copolymer, the ethylene-acrylic ester copolymer and the ethylene-methacrylic ester copolymer are preferably used.

Examples of the polyethylene include high density polyethylene (HDPE), middle density polyethylene (MDPE), low density polyethylene (LDPE), linear low density polyethylene (LLDPE) and very low density polyethylene (VLDPE), and metallocene very low density polyethylene. They may be used singly or in combination. Among them, the low density polyethylene typified by the metallocene very low density polyethylene is preferably used. Using the low density polyethylene improves the flexibility and extrudability of a wire, which can leads to better productivity.

Examples of the polyolefins may include an olefin-based elastomer such as an ethylene elastomer (PE elastomer) and a propylene elastomer (PP elastomer). They may be used singly or in combination.

It is preferable to use a one or a plurality of polyolefins, which are selected from the group consisting of the VLDPE, LLDPE and LDPE, for the polyolefin used in (A) the silane-grafted polyolefin from the viewpoint of extrudability and productivity of a wire in coating the wire with the composition, and flexibility of the wire. Examples of a silane coupling agent used in (A) the silane-grafted polyolefin include vinylalkoxysilane such as vinyltrimethoxysilane, vinyltriethoxysilane and vinyltributoxysilane, normal hexyl trimethoxysilane, vinylacetoxysilane, gamma-methacryloxypropyltrimethoxysilane, and gamma-methacryloxypropylmethyldimethoxysilane. They may be used singly or in combination.

The content of the silane coupling agent in (A) the silane-grafted polyolefin is preferably in the range of 0.5 to 5 parts by mass, and more preferably in the range of 3 to 5 parts by mass with respect to 100 parts by mass of the polyolefin onto which the silane coupling agent is to be grafted. If the content is less than 0.5 parts by mass, the graft amount of the silane coupling agent is too small, which makes it difficult for the composition to obtain a sufficient crosslinking degree during a silane crosslinking process. On the other hand, if the content is more than 5 parts by mass, a crosslinking reaction proceeds excessively to generate a gel-like material during a kneading process. In such a case, asperities are liable to appear on a product surface, which decreases mass productivity of the product. In addition, melt viscosity of the composition becomes too high and an excessive load is applied on an extruder, which results in decreased workability.

A graft amount of the silane coupling agent (a mass ratio of the grafted silane coupling agent to the polyolefin before silane grafting is performed) is preferably 15% by mass or less, more preferably 10% by mass or less, and yet more preferably 5% by mass or less in case an unintended substance is generated due to excessive crosslinking during a wire coating process. To be specific, when the graft amount of the silane coupling agent increases too much, an unreacted silane coupling agent is liable to be liberated. On the other hand, the graft amount is preferably 0.1% by mass or more, more preferably 1% by mass or more, and yet more preferably 2.5% by mass or more from the viewpoint of crosslinking degree (gel fraction) of a wire coat.

The silane coupling agent is grafted onto the polyolefin generally in a manner such that a free-radical generating agent is added to the polyolefin and the silane coupling agent and all the materials are mixed with the use of a twin-screw extruder. It is also preferable that the silane coupling agent is grafted onto the polyolefin in a method such that the silane coupling agent is added when grafting the silane coupling agent onto the polyolefin. The silane-grafted polyolefin prepared by grafting the silane coupling agent onto the polyolefin is kept as a silane-grafted polyolefin batch (an (a) component) while separated from (b) and (c) components until the composition is kneaded.

Examples of the free-radical generating agent include an organic peroxide such as dicumyl peroxide (DCP) benzoyl peroxide, dichlorobenzoyl peroxide, di-tert-butyl peroxide, butyl peracetate, tert-butyl perbenzoate, and 2,5-dimethyl-2,5-di(tert-butyl peroxy)hexane. Among them, the dicumyl peroxide (DCP) is preferably used. When the dicumyl peroxide (DCP) is used as the free-radical generating agent, it is preferable to adjust the silane-grafted polyolefin batch to be 200 degrees C. or more in order to graft-polymerize the silane coupling agent onto the polyolefin.

The content of the free-radical generating agent is preferably in the range of 0.025 to 0.1 parts by mass with respect to 100 parts by mass of the polyolefin to be silane-modified. If the content is less than 0.025 parts by mass, a grafting reaction of the silane coupling agent does not proceed sufficiently, which makes it difficult for the composition to obtain a desired gel fraction. On the other hand, if the content is more than 0.1 parts by mass, the ratio of breaking the molecules of the polyolefin rises, so that unintentional crosslinking of the peroxide proceeds. In such a case, a crosslinking reaction of the polyolefin proceeds excessively, and asperities are liable to appear on a product surface when the silane-grafted polyolefin batch is mixed with a batch containing a flame retardant agent and a batch containing a catalyst. To be specific, when the wire coating material is molded, asperities appear on a surface of the wire coating material, and the wire is liable to have decreased workability and marred surface appearance.

(B) The unmodified polyolefin defines polyolefin that is not modified by a silane coupling agent or a functional group. It is preferable to use a one or a plurality of polyolefins, which are selected from the group consisting of the VLDPE, LLDPE and LDPE, for the unmodified polyolefin from the viewpoint of providing a wire with flexibility and dispersing a filler that defines a flame retardant agent well. In addition, it is preferable to add a small amount of polypropylene for hardness adjustment in order to control the flexibility of a wire.

As the polyolefin that is used in (C) the functional-group modified polyolefin, it is preferable to use a resin of a same group as the resin used as the unmodified polyolefin from the viewpoint of compatibility. In addition, polyethylene such as the VLDPE and LDPE is preferably used as the polyolefin used in (C) the functional-group modified polyolefin from the viewpoint of providing a wire with flexibility and dispersing a filler that defines a flame retardant agent well.

As a functional group that is used in (C) the functional-group modified polyolefin, a one or a plurality of functional groups selected from the group consisting of a carboxylic acid group, an acid anhydride group, an amino group, and an epoxy group are used. Among them, the maleic acid group, the epoxy group and the amino group are preferably used because these functional groups can improve an adhesion property to fillers such as a bromine flame retardant, an antimony trioxide and a zinc oxide to prevent the strength of the resin from decreasing. The modification ratio by the functional group is preferably in the range of 0.005 to 10 parts by mass with respect to 100 parts by mass of the polyolefin. If the modification ratio of the functional group is more than 10 parts by mass, a property of stripping a coat at the time of processing ends of a wire could be degraded. On the other hand, if the modification ratio by the functional group is less than 0.005 parts by mass, the effect of modification by the functional group could be insufficient.

The polyolefin is modified by the functional group in a method of graft-polymerizing a compound containing the functional group onto the polyolefin, or in a method of copolymerizing a compound containing the functional group and an olefin monomer to obtain an olefin copolymer.

Examples of a compound for introducing the carboxylic acid group and/or the acid anhydrous group that defines the functional group include an alpha, beta-unsaturated dicarboxylic acid such as a maleic acid, a fumaric acid, a citraconic acid and an itaconic acid, anhydrides thereof, and an unsaturated monocarboxylic acid such as an acrylic acid, a methacrylic acid, a fran acid, a crotonic acid, a vinylacetic acid and a pentane acid.

Examples of a compound for introducing the amino group that defines the functional group include aminoethyl(meth)acrylate, propylaminoethyl(meth)acrylate, dimethyl aminoethyl(meth)acrylate, diethyl aminoethyl(meth)acrylate, dibutyl aminoethyl(meth)acrylate, aminopropyl(meth)acrylate, phenylaminoethyl(meth)acrylate, and cyclohexylaminoethyl(meth)acrylate. It is to be noted that acrylate and/or methacrylate is expressed as (meth)acrylate in the present specification.

Examples of a compound for introducing the epoxy group that defines the functional group include glycidyl acrylate, glycidyl methacrylate, an itaconic monoglycidyl ester, a butene tricarboxylic acid monoglycidyl ester, a butene tricarboxylic acid diglycidyl ester, a butenetricarboxylicacidtriglycidyl ester, glycidyl esters such as an alpha-chloroacrylic acid, a maleic acid, a crotonic acid and a fumaric acid, glycidyl ethers such as a vinyl glycidyl ether, an allyl glycidyl ether, a glycidyl oxyethyl vinyl ether and a styrene-p-glycidyl ether, and p-glycidyl styrene.

The ratio of the content of (A) the silane-grafted polyolefin to the total content of (B) the unmodified polyolefin and (C) the functional-group modified polyolefin is 30 to 90 parts by mass to 10 to 70 parts by mass with respect to 100 parts by mass of the total content of the (A), (B) and (C) resin components. The content ratio of (B) the unmodified polyolefin to (C) the functional-group modified polyolefin is preferably in the range of 95:5 to 50:50 from the viewpoint of providing excellent compatibility, and favorable productivity and dispersibility.

(D) The bromine flame retardant having the phthalimide structure has a low degree of solubility in hot xylene, and thus has a favorable gel fraction. Examples of the bromine flame retardant having the phthalimide structure include ethylene bis tetrabromophthalimide and ethylene bis tribromophthalimide.

It is preferable to singly use one of the bromine flame retardants having the phthalimide structure described above for the bromine flame retardant. It is also preferable to use in combination with the following bromine flame retardants insofar as a desired gel fraction can be obtained. Examples of (C) the bromine flame retardant include ethylenebis (pentabromobenzene) [also known as bis(pentabromophenyl)ethane], tetrabromobisphenolA (TBBA), hexabromocyclododecane (HBCD), TBBA-carbonate oligomer, TBBA-epoxy oligomer, brominated polystyrene, TBBA-bis(dibromopropylether) poly (dibromopropylether), and hexabromobenzene (HBB).

The antimony trioxide is used as a flame-retardant auxiliary agent for the bromine flame retardant. Use of the antimony trioxide together with the bromine flame retardant generates a synergistic effect to improve the flame retardancy of the composition. The content ratio of the bromine flame retardant having the phthalimide structure to the antimony trioxide is preferably in the range of 3:1 to 2:1 at the equivalent ratio. It is preferable to use antimony trioxide having a purity of 99% or more. The antimony trioxide is prepared by pulverizing and microparticulating antimony trioxide that is produced as a mineral. The microparticulated antimony trioxide has an average particle size of preferably 3 μm or less, and more preferably 1 μm or less. If the average particle size of the antimony trioxide is larger, the interface strength between the antimony trioxide and the resins could be decreased. In addition, the antimony trioxide may be subjected to a surface treatment in order to adjust the particle size or improve the interface strength between the antimony trioxide and the resins. Examples of the surface treatment agent include a silane coupling agent, a higher fatty acid and a polyolefin wax.

The total content of (D) the bromine flame retardant and the antimony trioxide that define components of the flame retardant agent is preferably in the range of 10 to 70 parts by mass, and more preferably in the range of 20 to 60 parts by mass with respect to 100 parts by mass of the total content of the (A), (B) and (C) resin components. If the total content of the flame retardant agent components is less than 10 parts by mass, the composition has insufficient flame retardancy. On the other hand, if the total content is more than 70 parts by mass, the flame retardant agent components cannot be mixed well to cause coagulation of the flame retardant agent, so that the interface strength between the flame retardant agent and the resins is decreased to deteriorate a mechanical property of a wire.

(E) The crosslinking catalyst defines a silanol condensation catalyst for silane crosslinking the silane-grafted polyolefin. Examples of the crosslinking catalyst include a metal carboxylate containing a metal such as tin, zinc, iron, lead and cobalt, a titanate ester, an organic base, an inorganic acid, and an organic acid. Specific examples of (E) the crosslinking catalyst include dibutyltin dilaurate, dibutyltin dimalate, dibutyltin mercaptide (e.g., dibutyltin bis-octylthioglycolate, a dibutyltin beta-mercaptopropionate polymer), dibutyltin diacetate, dioctyltin dilaurate, stannous acetate, stannous caprylate, lead naphthenate, cobalt naphthenate, barium stearate, calcium stearate, titanic acid tetrabutyl ester, titanic acid tetranonyl ester, dibutylamine, hexylamine, pyridine, a sulfuric acid, a hydrochloric acid, a toluenesulfonic acid, an acetate, a stearic acid, and a maleic acid. Among them, the dibutyltin dilaurate, the dibutyltin dimalate, and the dibutyltin mercaptide are preferably used.

The crosslinking catalyst is usually added to the resin components during a wire coating process because a crosslinking reaction proceeds if the crosslinking catalyst is mixed with the silane-grafted polyolefin batch (the batch is referred to also as an (a) component). The crosslinking catalyst is added to the resin components in a method such that the crosslinking catalyst is contained together with the flame retardant agent in a batch when preparing the flame retardant batch (the batch is referred to also as a (b) component), or in a method such that only the crosslinking catalyst and a binder resin are mixed to prepare a separate batch containing a crosslinking catalyst (the batch is referred to also as a (c) component). While the crosslinking catalyst may be added to the resin components in either method, it is preferable to use the method of preparing the separate crosslinking catalyst batch. This method can prevent the crosslinking catalyst from excessively reacting with the flame-retardant agent because such a reaction could occur when the crosslinking catalyst is mixed with the flame retardant agent. In addition, this method allows easy adjustment of the content of the crosslinking catalyst.

It is preferable to use polyolefin as the resin used in the crosslinking catalyst batch, and more preferable to use LDPE, LLDPE or VLDPE. These resins are preferably used based on the same reasons as the silane-grafted polyolefin, the undenatured polyolefin and the functional-group modified polyolefin. It is advantageous to select resins of the same group from the viewpoint of compatibility. Specific examples of the polyolefin include the polyolefins described above.

The content of the crosslinking catalyst in the crosslinking catalyst batch is preferably in the range of 0.5 to 5 parts by mass, and more preferably in the range of 1 to 5 parts by mass with respect to 100 parts by mass of the resin component in the crosslinking catalyst batch. If the content is more than 5 parts by mass, the catalyst is not dispersed well and its reactivity per mass decreases. Thus, the crosslinking catalyst batch needs to be added more than necessary, which could exert a harmful influence on the physical properties of a wire.

The content of the crosslinking catalyst batch is preferably in the range of 2 to 20 parts by mass, and more preferably in the range of 5 to 15 parts by mass with respect to 100 parts by mass of the total content of the (A), (B) and (C) resin components. If the content is less than 2 parts by mass, crosslinking does not proceed well, which could result in partial crosslinking. On the other hand, if the content is more than 20 parts by mass, the non-crosslinkable non-flame-retardant resin increases to exert a harmful influence on the flame retardancy and weatherability of the composition.

(F) The zinc sulfide, or the zinc oxide and the imidazole compound, are contained in the composition as an additive to improve heat resistance. Even when the zinc sulfide is contained alone, or the zinc oxide and the imidazole compound are contained in combination, a same effect of heat resistance can be produced in both of the cases.

The zinc oxide is produced in a method of oxidizing zinc vapors, which exude from a zinc mineral by adding a reducing agent such as coke thereto and firing the zinc mineral, by air, or in a method of producing from a zinc sulfide or a zinc chloride. The production method of the zinc oxide is not limited specifically. The zinc oxide may be produced in either method. The zinc sulfide may be produced in a known production method. The zinc oxide and the zinc sulfide have an average particle size of preferably 3 μm or less, and more preferably 1 μm or less. If the average particle size of the zinc oxide and the zinc sulfide is smaller, the interface strength between the zinc oxide or the zinc sulfide and the resins is improved, which improves dispersibility.

Mercaptobenzimidazole is preferably used as the imidazole compound. Examples of the mercaptobenzimidazole include 2-mercaptobenzimidazole, 2-mercaptomethylbenzimidazole, 4-mercaptomethylbenzimidazole, 5-mercaptomethylbenzimidazole, and zinc salt thereof. Among them, the 2-mercaptobenzimidazole and the zinc salt thereof are preferably used because they have high melting points, and are stable at high temperatures because only a small amount of the 2-mercaptobenzimidazole or, the zinc salt thereof sublime during the mixing.

If the content of the zinc sulfide, or the content of the zinc oxide and the imidazole compound is too small, an effect of improving heat resistance cannot be obtained sufficiently. On the other hand, if the content is too large, the particles are liable to coagulate, and a wire is liable to have marred surface appearance, and mechanical properties such as wear resistance of the wire could be deteriorated. Thus, the content is preferably in the ranges described below. The content of the zinc sulfide is preferably 1 to 15 parts by mass, or the content of each of the zinc oxide and the imidazole compound is 1 to 15 parts by mass with respect to 100 parts by mass of the total content of the (A), (B) and (C) resin components.

It is preferable that the composition for the wire coating material of the present invention further contains a general additive in addition to the components described above. Examples of the additive favorably used include a hindered phenolic antioxidant and an amine copper inhibitor. In addition, an additive that is generally used for a wire coating material can be used.

If a filler such as magnesium hydroxide, magnesium oxide and calcium carbonate is added as the additive, the hardness of the resins can be adjusted, whereby workability and high heat deformation resistance can be improved. If a great amount of the filler is added, the resins decrease in strength. Thus, the content of the filler is preferably about 30 parts by mass with respect to 100 parts by mass of the resin components.

Next, a description of an insulated wire of a preferred embodiment of the present invention will be provided. The insulated wire includes a conductor and an insulation layer, coated on the conductor, the insulation layer being made from a wire coating material that is prepared by water-crosslinking the composition for the wire coating material described above. The diameter, the material and other properties of the conductor are not specifically limited, and may be determined appropriately depending on intended use of the insulated wire. The conductor is made from copper, a copper alloy, aluminum or an aluminum copper alloy. The insulation layer made from the wire coating material may have a single-layered configuration, or may have a multi-layered configuration. A wiring harness of the present invention includes the insulated wire described above.

The ISO 6722 is an international standard used for a wire for automobile. The insulated wire is classified under A to E classes in accordance with the ISO 6722 depending on its allowable temperature limit. Being made from the composition for the wire coating material described above, the insulated wire of the present invention is excellent in heat resistance, and can be favorably used for a cable for battery where a high voltage is placed. Thus, the insulated wire of the present invention can have the properties of C class where the required allowable temperature limit is 125 degrees C., or the properties of D class where the required allowable temperature limit is 150 degrees C.

In the insulated wire of the present invention, the wire coating material preferably has a crosslinking degree of 50% more, and more preferably has a crosslinking degree of 60% or more from the viewpoint of heat resistance. The crosslinking degree is determined by a gel fraction that is generally used as an indicator that indicates a crosslinking state of a crosslinked wire. For example, the gel fraction of a crosslinked wire for automobile can be measured in accordance with the JASO-D608-92. The crosslinking degree can be adjusted by the graft amount of the silane coupling agent grafted on the olefin resin, the kind and amount of the crosslinking catalyst, or the conditions for water-crosslinking (temperature and duration).

Next, a description of a method for producing the insulated wire will be provided. The insulated wire is produced by subjecting the (a) component that contains (A) the silane-grafted polyolefin (the silane-grafted polyolefin batch), the (b) component that contains (B) the undenatured polyolefin, (C) the functional-group modified polyolefin, (D) the flame retardant agent and (F) the zinc sulfide or the zinc oxide and the imidazole compound (the flame retardant batch), and the (c) component that contains the polyolefin and (E) the crosslinking catalyst dispersed in the polyolefin (the crosslinking catalyst batch) to a kneading process where the components are heat-kneaded. Then, the wire coating material is subjected to a coating process where the conductor is extrusion-coated with the wire coating material, and is then subjected to a water-crosslinking process. Each of the (b) and (c) components is kneaded in advance to be pelletized. The silane-grafted polyolefin in the (a) component is also pelletized.

The pelletized batches (the (a), (b) and (c) components) are blended with the use of a mixer or an extruder in the kneading process. The extrusion-coating is performed preferably with the use of a general extrusion molding machine in the coating process. After the coating process, the resin that coats the conductor of the wire is water-crosslinked by being exposed to vapor or water, and thus is silane-crosslinked. It is preferable to perform the water-crosslinking at temperatures between room temperature to 90 degrees C. within 48 hours, and more preferable to perform the water-crosslinking at temperatures between 60 to 80 degrees C. for 12 to 24 hours.

### EXAMPLE

Hereinafter, Examples of the present invention, and Comparative Examples are presented. However, the present invention is not limited to the Examples.

[Materials Used, Manufacturers, and Other Information]

Materials used in the Examples and Comparative Examples are provided below along with their manufacturers and trade names.
Silane-grafted PP [manuf.: MITSUBISHI CHEMICAL CORPORATION, trade name: LINKLON XPM800HM]
Silane-grafted PE1 [manuf.: MITSUBISHI CHEMICAL CORPORATION, trade name: LINKLON XLE815N (LLDPE)]
Silane-grafted PE2 [manuf.: MITSUBISHI CHEMICAL CORPORATION, trade name: “LINKLON XCP710N” (LDPE)]
Silane-grafted PE3 [manuf.: MITSUBISHI CHEMICAL CORPORATION, trade name: “LINKLON QS241HZ” (HDPE)]
Silane-grafted PEA [manuf.: MITSUBISHI CHEMICAL CORPORATION, trade name: “LINKLON SH700N” (VLDPE)]
Silane-grafted EVA (manuf.: MITSUBISHI CHEMICAL CORPORATION, trade name: “LIMON XVF600N”)
PP elastomer [manuf.: JAPAN POLYPROPYLENE CORPORATION, trade name: “NEWCON WARS”]
PE 1 [manuf.: DUPONT DOW ELASTOMERS JAPAN KK, trade name: “ENGAGE 8450” (VLDPE)]
PE 2 [manuf.: NIPPON UNICAR COMPANY LIMITED, trade name: “NUC8122” (LDPE)]
PE 3 [manuf.: PRIME POLYMER CO., LTD, trade name: “ULTZEX10100W” (LLDPE)]
Maleic acid denatured PE [manuf.: NOF CORPORATION, trade name: “MODIC AP512P”]
Epoxy denatured FE [manuf.: SUMITOMO CHEMICAL CO., LTD., trade name: “BONDFAST E” (E-GMA)]
Maleic acid denatured PP [manuf.: MITSUBISHI CHEMICAL CORPORATION, trade name: “ADMER QB550”]
Bromine flame retardant 1 [manuf.: ALBEMARLE JAPAN CORPORATION, trade name: “SAYTEX8010” (ethylenebis (pentabromobenzene))]
Bromine flame retardant 2 [manuf.: SUZUHIRO CHEMICAL CO., LTD., trade name: “FCP-680” (TBBA-bis(dibromopropylether))]
Bromine flame retardant 3 [manuf.: ALBEMARLE JAPAN CORPORATION, trade name: “SAYTEXBT-93” (ethylene bis tetrabromophthalimide)]
Antimony trioxide: [manuf.: YAMANAKA & CO., LTD., trade name: “ANTIMONY TRIOXIDE MSW GRADE”]
Antioxidant 1 [Manuf.: CIBA SPECIALTY CHEMICALS INC., trade name: “IRGANOX 1010”]
Antioxidant 2 [Manuf.: CIBA SPECIALTY CHEMICALS INC., trade name: “IRGANOX 3114”]
Magnesium hydroxide (manuf.: KYOWA CHEMICAL INDUSTRY CO., LTD., trade name: “KISUMA 5”)
Calcium carbonate [manuf.: SHIRAISHI CALCIUM KAISHA, LTD., trade name: “VIGOT15”]
Copper inhibitor [Manuf.: ADEKA CORPORATION, trade name: CDA-1]
Zinc oxide [Manuf.: HAKUSUITECH CO., LTD., trade name: “ZINC OXIDE JIS2”]
Zinc sulfide [Manuf.: SACHTLEBEN CHEMIE GMBH, trade name: “SACHTOLITH HD-S”]
Additive [Manuf.: KAWAGUCHI CHEMICAL INDUSTRY CO., LTD., trade name: “ANTAGE MB”]
Lubricant 1 [Manuf.: NOF CORPORATION, trade name: “ALFLOW P10” (erucic acid amide)]
Lubricant 2 [Manuf.: NOF CORPORATION, trade name: “ALFLOW 810” (stearic acid amide)]
Crosslinking catalyst batch [manuf.: MITSUBISHI CHEMICAL CORPORATION, trade name: “LINKLON LZ0515H” (catalyst type: tin compound, content: less than 1%, resin: polyethylene)]

[Preparation of Flame Retardant Batches ((b) Components)]

Flame-retardant batches were prepared as follows: materials were prepared at the ratios of the (b) components of the Examples and Comparative Examples indicated in Tables 1 and 2, and were separately put into a twin-screw kneading extruder. Each of the materials was heat-kneaded at 200 degrees C. for 0.1 to 2 minutes, and then was pelletized. Concerning the (a) and (c) components, the commercially available materials described above, which were already pelletized, were used as they were as the silane-grafted polyolefin batch and the crosslinking catalyst batch.

[Preparation of Insulated Wires]

The silane-grafted polyolefin batches (the (a) components), the flame retardant batches (the (b) components), and the crosslinking catalyst hatches (the (c) components) at the ratios of the Examples and Comparative Examples indicated in Tables 1 and 2 were blended by using a hopper of an extruder at about 180 to 200 degrees C., and subjected to extrusion processing. Conductors having an external diameter of 2.4 mm were extrusion-coated with thus-prepared materials as insulators having a thickness of 0.7 mm (i.e., the external diameter of the insulated wires after the extrusion-coating was 3.8 mm). Then, each material was water-crosslinked in a bath at a high humidity of 95% at a high temperature of 60 degrees C. for 24 hours. Thus, insulated wires consistent with Examples and Comparative Examples were prepared.

Evaluations of the obtained insulated wires were made in terms of gel fraction, productivity and flame retardancy, and by carrying out the ISO long-time heating test. The evaluation results are presented in Tables 1 and 2. The test procedures and the evaluations are described below.

[Gel Fraction]

The gel fractions of the insulated wires were measured in accordance with the JASO-D608-92. To be specific, about 0.1 g of test samples of the insulators of the insulated wires were each weighed out and put in test tubes. 20 ml xylene was added to each sample, and then, each sample was heated in a constant temperature oil bath at 120 degrees C. for 24 hours. Then, each sample was taken out from the test tube to be dried in a dryer at 100 degrees C. for 6 hours. Each sample was cooled to room temperature and precisely weighed. The percentages of the masses of the test samples after the test to the masses of the test samples before the test were defined as gel fractions. The test samples having gel fractions of 60% or more were regarded as excellent. The test samples having gel fractions of 50% or more were regarded as good. The test samples having gel fractions of less than 50% were regarded as bad.

[Productivity]

The linear speed of each insulated wire was increased and decreased when each insulated wire was being extruded. The insulated wires that could have a designed external diameter even at the linear speed of 50 m/min or more were regarded as good. The insulated wires that could have a designed external diameter even at the linear speed of 100 m/min or more were regarded as excellent.

[Flame Retardancy]

A flame retardancy test was carried out in accordance with the ISO 6722. The insulated wires that were extinguished within 70 seconds were regarded as good. The insulated wires that were not extinguished within 70 seconds were regarded as bad.

[ISO Long-Time Heating Test]

An aging test was carried out on each of the insulated wires in accordance with the ISO 6722 at 150 degrees C. for 3000 hours, and then a withstand voltage test of 1 kv×1 minute was carried out on each of the insulated wires. The insulated wires that could stand the withstand voltage test without insulation breakdown were regarded as good. The insulated wires that could not stand the withstand voltage test without insulation breakdown were regarded as bad.

TABLE 1

| | Example 1 | | Example 2 | | Example 3 | | Example 4 | | Example 5 | | Example 6 | | Example 7 | |
|---|---|---|---|---|---|---|---|---|---|---|---|---|---|---|
| Component ratio | b com- | | b com- | | b com- | | b com- | | b com- | | b com- | | b com- | |
| (part by mass) | ponent | | ponent | | ponent | | ponent | | ponent | | ponent | | ponent | |
| Silane-grafted PP | | 30 | | | | | | | | | | | | |
| Silane-grafted PE1 | | | | 60 | | | | | | | | | | |
| Silane-grafted PE2 | | | | | | 90 | | | | | | | | 60 |
| Silane-grafted PE3 | | | | | | | | 60 | | | | | | |
| Silane-grafted PE4 | | | | | | | | | | 60 | | | | |
| Silane-grafted EVA | | | | | | | | | | | | 60 | | |
| PP elastomer | 10 | | | | | | 5 | | | | | | 5 | |
| PE1 | 50 | | | | | | 30 | | 5 | | | | 30 | |
| PE2 | | | 30 | | | | | | 30 | | | | | |
| PE3 | | | | | 5 | | | | | | 35 | | | |
| Maleic acid denatured PE | | | 10 | | | | 5 | | 5 | | | | 5 | |
| Epoxy denatured PE | 10 | | | | | | | | | | | | | |
| Maleic acid denatured PP | | | | | 5 | | | | | | 5 | | | |
| Bromine flame retardant 1 | | | | | | | | | | | 10 | | | |
| Bromine flame retardant 2 | | | 5 | | | | 50 | | | | | | | |
| Bromine flame retardant 3 | 100 | | 5 | | 20 | | 20 | | 10 | | 5 | | 30 | |
| Antimony trioxide | 5 | | 3 | | 10 | | | | 20 | | 70 | | 10 | |
| Magnesium hydroxide | | | 30 | | | | | | | | 50 | | | |
| Calcium carbonate | | | | | | | | | 20 | | | | | |
| Zinc oxide 1 | 1.5 | | 3 | | 1.5 | | 1.5 | | 1.5 | | 1.5 | | | |
| Zinc oxide 2 | 1.5 | | 3 | | 1.5 | | 1.5 | | 1.5 | | 1.5 | | 3 | |
| Copper inhibitor | 1 | | 1 | | 1 | | 1 | | 1 | | 1 | | 1 | |
| Zinc oxide | 5 | | 1 | | 7 | | | | | | | | 10 | |
| Zinc sulfide | | | | | | | 5 | | 10 | | 15 | | | |
| Additive | 5 | | 1 | | 7 | | | | | | | | 10 | |
| Lubricant 1 | | | | | | | 1 | | | | 1 | | 1 | |
| Lubricant 2 | | | | | | | | | 1 | | | | | |
| Crosslinking catalyst batch | | 2 | | 5 | | 20 | | 5 | | 5 | | 5 | | 10 |
| Subtotal | 189 | 32 | 92 | 65 | 58 | 110 | 120 | 65 | 105 | 65 | 195 | 65 | 105 | 70 |

| | | | | | | | |
|---|---|---|---|---|---|---|---|
| Sum total | 221 | 157 | 168 | 185 | 170 | 260 | 175 |
| Gel fraction | Excellent | Good | Excellent | Good | Excellent | Good | Excellent |
| Productivity | Good | Excellent | Excellent | Good | Excellent | Good | Excellent |
| Flame retardancy | Good | Good | Good | Good | Good | Good | Good |
| ISO long-time heating test | Good | Good | Good | Good | Good | Good | Good |

TABLE 2

| | Comparative | | Comparative | | Comparative | | Comparative | | Comparative | |
|---|---|---|---|---|---|---|---|---|---|---|
| Component ratio | Example 1 | | Example 2 | | Example 3 | | Example 4 | | Example 5 | |
| (part by mass) | b component | | b component | | b component | | b component | | b component | |
| Silane-grafted PP | | 30 | | | | | | | | |
| Silane-grafted PE1 | | | | | | | | | | |
| Silane-grafted PE2 | | | | | | | | | | |
| Silane-grafted PE3 | | | | | | | | 60 | | |
| Silane-grafted PE4 | | | | | | 100 | | | | 70 |
| Silane-grafted EVA | | | | | | | | | | |
| PP elastomer | 10 | | | | | | 5 | | | |
| PE1 | 50 | | | | | | 30 | | | |
| PE2 | | | 90 | | | | | | 30 | |
| PE3 | | | | | | | | | | |
| Maleic acid denatured PE | | | 10 | | | | 5 | | | |
| Epoxy denatured PE | 10 | | | | | | | | | |
| Maleic acid denatured PP | | | | | | | | | | |
| Bromine flame retardant 1 | | | | | | | | | | |
| Bromine flame retardant 2 | | | 8 | | | | 70 | | | |
| Bromine flame retardant 3 | | | | | | | 20 | | | |
| Antimony trioxide | | | 10 | | | | | | | |
| Magnesium hydroxide | | | 30 | | | | | | | |
| Calcium carbonate | | | | | | | | | 10 | |
| Zinc oxide 1 | 1.5 | | 3 | | | | | | 1.5 | |
| Zinc oxide 2 | 1.5 | | 3 | | | | | | 1.5 | |
| Copper inhibitor | 1 | | 1 | | | | | | 1 | |
| Zinc oxide | 5 | | 1 | | | | | | | |
| Zinc sulfide | | | | | | | | | 10 | |
| Additive | 5 | | 1 | | | | | | | |
| Lubricant 1 | | | | | | | 1 | | | |
| Lubricant 2 | | | | | | | | | 1 | |
| Crosslinking catalyst batch | | 5 | | 5 | | | | 5 | | 5 |
| Subtotal | 84 | 35 | 157 | 5 | 0 | 100 | 131 | 65 | 55 | 75 |

| | | | | | |
|---|---|---|---|---|---|
| Sum total | 119 | 162 | 100 | 196 | 130 |
| Gel fraction | Bad | Bad | Bad | Excellent | Bad |
| Productivity | Good | Excellent | Excellent | Good | Excellent |
| Flame retardancy | Bad | Good | Bad | Good | Bad |
| ISO long-time heating test | Good | Bad | Bad | Bad | Bad |

As is evident from Table 2, the compositions of Comparative Examples 1 to 5 do not contain all the components specified by the present invention, so that the insulated wires consistent with Comparative Examples 1 to 5 do not have properties that can satisfy the requirements of the insulated wires of the present invention. To be specific, the composition of Comparative Example 1 does not contain a bromine flame retardant while the composition of Example 1 contains, so that the composition of Comparative Example 1 is regarded as bad in flame retardancy and gel fraction. The composition of Comparative Example 2 does not contain silane-grafted polyolefin and is made only of a non-crosslinked resin, so that the composition of Comparative Example 2 is regarded as bad in gel fraction and the ISO long-time heating test. The composition of Comparative Example 3 is made only of silane-grafted polyolefin and does not contain any other resin, flame retardant agent or crosslinking catalyst, so that the composition of Comparative Example 3 is regarded as bad in gel fraction, flame retardancy and the ISO long-time heating test. The composition of Comparative Example 4 does not contain zinc oxide, zinc sulfide or an imidazole compound, so that the composition of Comparative Example 4 is regarded as bad in the ISO long-time heating test. The composition of Comparative Example 5 does not contain functional-group modified polyolefin or a flame retardant agent, so that the composition of Comparative Example 5 is regarded as bad in gel fraction, flame retardancy and the ISO long-time heating test.

Meanwhile, the compositions of present Examples 1 to 7 contain the silane-grafted polyolefin, the undenatured polyolefin, the functional-group modified polyolefin, the bromine flame retardant having the phthalimide structure, the crosslinking catalyst, and the zinc sulfide, so that the compositions of present Examples 1 to 7 are good in gel fraction, productivity, flame retardancy, and the ISO long-time heating test.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1. A composition for a wire coating material, the composition containing:
(A) silane-grafted polyolefin, which is polyolefin to which a silane coupling agent is grafted;
(B) undenatured polyolefin;
(C) functional-group modified polyolefin, which is modified by a one or a plurality of functional groups selected from the group consisting of a carboxylic acid group, an acid anhydride group, an amino group, and an epoxy group;
(D) either one of
a bromine flame retardant having a phthalimide structure, and
a bromine flame retardant having a phthalimide structure and an antimony trioxide;
(E) a crosslinking catalyst; and
(F) either one of
a zinc sulfide, and
a zinc oxide and an imidazole compound.

2. The composition according to claim 1, wherein
the content of (A) the silane-grafted polyolefin is 30 to 90 parts by mass,
the total content of (B) the undenatured polyolefin and (C) the functional-group modified polyolefin is 10 to 70 parts by mass;
the total content of (D) the bromine flame retardant having the phthalimide structure and the antimony trioxide is 10 to 70 parts by mass with respect to 100 parts by mass of the total content of the (A), (B) and (C) components,
the content of a crosslinking catalyst batch, which contains polyolefin as a binder resin, and (E) the crosslinking catalyst dispersed in the polyolefin, is 2 to 20 parts by mass with respect to 100 parts by mass of the total content of the (A), (B) and (C) components, wherein the content of (E) the crosslinking catalyst is 0.5 to 5 parts by mass with respect to 100 part by mass of the polyolefin,
the content of (F) the zinc sulfide is 1 to 15 parts by mass, or the content of each of (F) the zinc oxide and the imidazole compound is 1 to 15 parts by mass with respect to 100 parts by mass of the total content of the (A), (B) and (C) components.

3. The composition according to claim 2, wherein each of the polyolefin of the silane-grafted polyolefin and the polyolefin of the undenatured polyolefin comprises a one or a plurality of polyethylene selected from the group consisting of very low density polyethylene, linear low density polyethylene, and low density polyethylene.

4. An insulated wire that contains a wire coating material that contains the composition for the wire coating material according to claim 3, the composition being water-crosslinked.

5-6. (canceled)

7. A wiring harness comprising the insulated wire according to claim 4.

8. An insulated wire that contains a wire coating material that contains the composition for the wire coating material according to claim 2, the composition being water-crosslinked.

9. A wiring harness comprising the insulated wire according to claim 8.

10. An insulated wire that contains a wire coating material that contains the composition for the wire coating material according to claim 1, the composition being water-crosslinked.

11. A wiring harness comprising the insulated wire according to claim 10.

12. The composition according to claim 1, wherein each of the polyolefin of the silane-grafted polyolefin and the polyolefin of the undenatured polyolefin comprises a one or a plurality of polyethylene selected from the group consisting of very low density polyethylene, linear low density polyethylene, and low density polyethylene.

13. An insulated wire that contains a wire coating material that contains the composition for the wire coating material according to claim 12, the composition being water-crosslinked.

14. A wiring harness comprising the insulated wire according to claim 13.

15. An insulated wire that contains a wire coating material that contains;
an (a) component that contains
(A) silane-grafted polyolefin, which is polyolefin to which a silane coupling agent is grafted;
a (b) component that contains:
(B) undenatured polyolefin;
(C) functional-group modified polyolefin, which is modified by a one or a plurality of functional groups selected from the group consisting of a carboxylic acid group, an acid anhydride group, an amino group, and an epoxy group;
(D) either one of
a bromine flame retardant having a phthalimide structure, and
a bromine flame retardant having a phthalimide structure and an antimony trioxide; and
(F) either one of
zinc sulfide, and
a zinc oxide and an imidazole compound; and
a (c) component that contains polyolefin, and
(E) a crosslinking catalyst dispersed in the polyolefin,
wherein the (a), (b) and (c) components are kneaded to be molded as the wire coating material, and the wire coating material is water-crosslinked.

16. A wiring harness comprising the insulated wire according to claim 15.
